(19) United States
(12) Patent Application Publication
(10) Pub. No.: US 2026/0295835 A1
(43) Pub. Date: Oct. 1, 2026

(54) JOINT SCALING OF A ROBOT ARM TRAJECTORY

(71) Applicant: Universal Robots A/S, Odense S (DK)

(72) Inventors: Rune Søe-Knudsen, Odense S (DK); Jens-Jakob Bentsen, Odense S (DK)

(73) Assignee: Universal Robots A/S, Odense S (DK)

(21) Appl. No.: 19/480,777

(22) PCT Filed: May 1, 2024
(86) PCT No.: PCT/DK2024/050101

§ 371 Date: Oct. 31, 2025

(30) Foreign Application Priority Data
May 2, 2023 (DK) PA202370213

(51) Int. Cl. B25J 9/16

(52) U.S. Cl. CPC B25J 9/1664

(57) ABSTRACT

The present invention relates to a method of transforming a robot arm trajectory having a motion profile, the method comprising the steps of: establish a robot arm trajectory including a first, second and a plurality of intermediate positions extending including spatial coordinates of the first and said second position. Establish spatial coordinates 5 of a further position not forming part of the established robot arm trajectory. Establish a spatial distance between the second and the further position. Establish a transformed robot arm trajectory including the first, further and the plurality of intermediate positions. Wherein at least part of the plurality of intermediate positions is propagated in space. Wherein the propagation: is a joint space propagation enabling the 10 transformed robot arm trajectory to reach the further position while maintaining the motion profile, and is based on the difference between the spatial coordinates of the second position and of the further position.

### FIELD OF THE INVENTION

The invention relates to method for a propagate an established robot arm trajectory in space and a robot arm implementing that method.

### BACKGROUND OF THE INVENTION

Recording a robot arm trajectory e.g., during a process of moving the robot arm by hand and record all or some of the positions during this movement is known in the art. Different standard operations such as blend are used to optimize the robot trajectory in terms of cycle time as well as adding new waypoints to the robot trajectory. Thus, it is known to record positions in space through which the robot arm has to move through or close by during a trajectory.

However, problems occur when either the start or target positions are to be changed e.g., due to a pick and place cycle, where these positions change from cycle to cycle. Then the robot programmer needs to do time consuming programming to change the robot trajectory according to the subsequent pick/place position.

### SUMMARY OF THE INVENTION

The inventors have identified the above-mentioned problems and challenges related to changing an already existing robot trajectory and solved these problems by the present invention as described below.

In an aspect, the invention relates to a method of transforming a robot arm trajectory having a motion profile, the method comprising the steps of:
establish said robot arm trajectory including a first position, a second position and a plurality of intermediate positions extending between said first position and said second position, wherein said established robot arm trajectory include coordinates of said first position and of said second position,
establish coordinates of a further position not forming part of said established robot arm trajectory,
establish a difference between said coordinates of said second position and said coordinates of said further position,
establish a transformed robot arm trajectory including said first position, said further position and said plurality of intermediate positions,
   wherein at least a part of said plurality of intermediate positions is propagated in space, wherein said propagation:
is a joint space propagation enabling said transformed robot arm trajectory to reach said further position while maintaining said motion profile, and
is based on the difference between said coordinates of said second position and said coordinates of said further position.

Transforming the established robot trajectory in joint space is advantageous in that it has effect, that singularity problems, otherwise related to transforming an established robot arm trajectory, can be avoided.

The trajectory of the robot arm is typically a series of recorded or programmed spatial positions that the robot arm is moved according to from a start position to a target position. Any of the start position and the target position may however be changed to the further position from one operation cycle to the next.

Replacing the start position and/or the target position with the further position is advantageous in that it has the effect, that in at least some of the positions (in theory all the positions) of a trajectory of the robot arm, subsequent the replacement, can be propagated according to the further position i.e. according to a new start or to a new target position, without reteaching the entire robot trajectory. In practise some of the positions of the trajectory are being propagated and some are defined by interpolation between the propagated positions. Accordingly, an advantageous method is provided, in which the propagation is based on the difference between coordinates of the second position and the further position. By basing the propagation on the difference between these coordinates an efficient way of transforming a robot arm trajectory may be achieved which may reduce the requirements of computational resources as opposed to more elaborate ways employing advanced algorithms for generalization of trajectories.

When referring to the robot arm moving through a point/position in space or is positioned in a position in space, a reference may be made to the spatial position of the robot joints or the robot arm at this position. This spatial position of the robot arm can be defined by (X, Y, Z) coordinates of a part of the robot arm, e.g., the tool flange or the tool center point (TCP) in the cartesian space or by robot joint angles in the joint space. Hence the spatial position of the robot tool center point can be described by one set of TCP coordinates in the cartesian space which (for most positions) can be reached/achieved with a plurality of different combinations of robot joint angles in joint space. Accordingly, coordinates of positions of a robot arm trajectory and coordinates of further position(s) may be expressed in both cartesian space and in joint space, as any coordinate of a robot joint in cartesian space may be translated into a set of joint angles. Likewise, any set of coordinates in joint space, e.g., joint angles, may be translated into a set of coordinates in cartesian space.

It is advantageous to maintain the motion profile when transforming the robot trajectory in that the motion profile e.g., may ensure that the robot does not collide with any obstacles within range of the robot arm. More specific it is advantageous in that manually defined waypoints can be avoided thereby making it easier and faster to program a robot arm. Thus, the present invention assists to lower the level of required experience of a use/programmer of the robot arm lowering a bar for automating an otherwise manual work process.

A robot trajectory is a path from a start position to a target position and if necessary, following a specific motion profile e.g., to avoid objects along this path. Establishing of a robot trajectory avoiding obstacles or changing of the original robot trajectory e.g., to avoid an obstacle is typically done in the Cartesian space. This is because it is intuitive for a human to think and work in the Cartesian space compared to the joint space. Working in the Cartesian space however, may lead to singularities which are not present in the joint space. The inventors of the present invention have come to the realization that movements which in the Cartesian space would lead to singularities are feasible in joint space. So, transforming a robot trajectory established in the Cartesian space to joints space increases the degree of freedom of operation of the robot arm. Hence, by the present invention, an unskilled programmer will be able to establish robot trajectories with a reduced risk of singularities.

Further, it is advantageous to transform a robot trajectory from Cartesian space to joint space in that the robot arm then will move with smoother curves leading to start and stops in/through points in space. Hence, the number of acceleration and deceleration of robot joints are reduced leading to an increased lifetime of the individual robot joints.

According to an embodiment, said coordinates of said first position, said second position, and said further position are spatial coordinates, and wherein said difference between said coordinates of said second position and said coordinates of said further position is a spatial distance.

According to an embodiment, said coordinates (or spatial coordinates) of said first position, said second position and said further position are coordinates in joint space. The coordinates of the positions (e.g., first position and second position) as well as the coordinates of the further position may be coordinates in joint space. Accordingly, a difference between said second position and said further position may also be a difference between the second position and the further position in joint space.

In an advantageous embodiment, said robot arm comprises a plurality of robot joints controllable by a robot controller to follow said robot arm trajectory.

The robot controller is controlling the spatial position of the robot joints according to the motion profile when following the robot arm trajectory.

In an advantageous embodiment, said robot arm trajectory and thereby said motion profile is established by a robot controller recording succeeding positions of said plurality of robot joints.

A user may move the robot arm i.e., the robot joints e.g., with the robot arm in free-drive mode, and simultaneously or at discrete points in time, when the robot joints are in a desired position, record a robot arm position. This is one way of establishing the robot trajectory.

According to an embodiment, said transformed robot arm trajectory has a different velocity profile than said robot arm trajectory.

The transformed robot arm trajectory may have a different velocity profile than the robot arm trajectory, i.e., it may be intended that the transformed robot arm trajectory is executed with a different velocity profile. Allowing different velocity profiles may be advantageous when for example the trajectory to be carried put is a simple movement between two positions and where the velocity of the robot arm does not substantially affect the quality of the trajectory. According to an alternative embodiment, the velocity profile of the transformed robot arm trajectory may be substantially similar, e.g., identical, to a velocity profile of the robot arm trajectory. Keeping the velocity profile substantially unchanged may be advantageous for certain applications such as for robot tasks involving welding or gluing where the velocity profile may be defined by the task to be carried out.

In an advantageous embodiment, said part of said plurality of intermediated positions is the majority of said plurality of intermediated positions of said established robot arm trajectory.

The majority of intermediate positions should be understood as more than half of the intermediate positions of the established robot trajectory such as at least 75% of the intermediate positions of the established robot trajectory is displaced when comparing the established robot trajectory and the transformed robot trajectory.

In an advantageous embodiment, said robot arm trajectory is a sub-robot arm trajectory of a complete robot arm trajectory including two or more sub-robot arm trajectories.

Dividing a robot trajectory into two or more sub-robot arm trajectories is a practical durable way of displacing an intermediate position to a further position. Hence, if the first and second positions are maintained, but one of the intermediated positions are to be displaced to the further position.

In an advantageous embodiment, said further position is a first position of a first robot trajectory and a second position of a second robot trajectory.

In this way, the further position may e.g., be defined as a target position of a first established robot trajectory and at the same time as a start position of a second established robot trajectory. This is advantageous in that in this way a robot trajectory can be divided in two (or more) sub-robot trajectories.

In an advantageous embodiment, said first position is a start position of said robot arm trajectory and said second position is a target position of said robot arm trajectory.

A robot program (executed by the robot controller) controlling movement of the robot arm may include a plurality of positions in which the robot arm can be positioned. One example of such position is the “home” position, which is not necessarily coincident with the same position in space as a start position. A start position of a robot arm trajectory may instead be defined as the first point in the part of a robot program that is repeated in successive cycles. Hence, an example of a start position may be above the position of an object to be moved by an end effector of the robot arm.

Continuing the above example, a target position may be where the object is positioned at the end of the cycle or sub-cycle in larger robot programs. However, the target position is not necessarily the last position on the repeated trajectory. When the robot arm has moved an object from start position to target position, the trajectory may move up (away) from the object before returning to the start position.

Accordingly, the by the present invention it is possible to change start position from one cycle of the robot program to the next. This may be advantageous in a bin picking application where a new start position can be determined for each pick as well as a new target position for each positioning of the picked object.

In an advantageous embodiment, said first position is a target position of said established robot arm trajectory and said second position is a start position of said established robot arm trajectory.

With this said, it should be mentioned, that the annotation of positions is not important. According to the method of the present invention, any position first, second or intermediate on the established robot arm trajectory may be displace. Hence, either the start position, the target position or both, or positions therebetween (intermediated positions) may be displaced according to the method of the present invention and thus forming the transformed robot arm trajectory.

In an advantageous embodiment, at least one of said plurality of intermediate positions is a waypoint.

The intermediated positions of the established robot trajectory may either be user-defined waypoints or robot controller defined positions e.g., positions sampled during recording of the robot arm trajectory through which the robot arm passes in its trajectory. Hence, a robot trajectory may be commanded through these positions or a defined distance from these positions or the robot controller automatically defines these intermediate positions. The first, second, further, additional further and intermediate positions may be referred to as user defined positions. The spatial positions between the first, second, further, additional further and intermediate positions, may be determined by the robot controller. Typically, the robot controller may use interpolation to determine the positions of the robot arm between two user defined positions.

In an advantageous embodiment, said first position, said second position and said plurality of intermediated positions are defined by said robot controller as positions in joint space.

These positions may from a starting point (when the robot trajectory is established) be defined in the Cartesian space. The robot controller may then transform or convert these positions to positions or robot joints angles in joints space to allow subsequent propagation of the established robot trajectory in joint space.

It should be mentioned that when referring to a position (such as a first, second, further, additional further or intermediate position) of the robot arm a reference is made to the robot joints in that position. More specific to the angular relationship between robot joints describing the position of the robot in a given position (such as a first, second, further, additional further or intermediate position). In the cartesian space a position of e.g., the tool center point may define the position of all robot joints whereas in the joints space the position of the tool center point may be described by different combinations of angles of the individual robot joint.

In an advantageous embodiment, said further position is provided to the robot controller by a user via a user interface to said robot controller as a position defined in the cartesian space.

The further position may be provided to the robot controller by a user via a user interface. In this case, the cartesian space is advantageous in that it is intuitive for the user. The spatial distance between the further position and the second position may then be determined by the robot controller and used as basis for the subsequent propagation of the established robot trajectory in joint space.

In an advantageous embodiment, said further position is provided to the robot controller by a user via a user interface to said robot controller as a position defined in joint space.

In an advantageous embodiment, said robot controller translate said further position defined in the cartesian space to a position defined in joint space.

This is advantageous in that the subsequent propagation of a position of the established robot trajectory to a position of the transformed robot trajectory (both robot trajectories having the same motion profiles) is less prone to singularity issues when made in joint space compared to a propagation made in the cartesian space.

In an advantageous embodiment, said further position is recorded by the robot controller as a current position of said robot in joint space.

The robot controller may establish the further position by recording a position while the robot is being manipulated in either physical by a user (in free-drive mode) or via moving the robot via the teach pendant. It is advantageous to record this further position in joint space by the robot controller.

In an advantageous embodiment, an additional further position is determined as a spatial distance from said first position.

In addition to establishing the further position and thereby displace either the start or the target position, the position not being displaced by the further position may be displaced by the additional further position. This is advantageous in that it has the effect, that both ends of the established robot arm trajectory may be transformed while maintaining the motion profile of the established robot arm trajectory.

Accordingly, according to the present invention, it is possible to transform an established robot arm trajectory at the start position, at the target position and at both the start position and target position of the established robot arm trajectory.

In an advantageous embodiment, said additional further position is provided to said robot controller as a distance defined in the cartesian space.

Providing positions to the robot controller in the cartesian space is advantageous in that it has the effect, that the cartesian space is more intuitive for a user to understand and thereby manipulate the robot in.

In an advantageous embodiment, said robot controller transform said additional further position received in the cartesian space to joints space.

This is advantageous in that a subsequent propagation of positions of the established robot arm trajectory made in joint spaces is less prone to singularity issues.

In an advantageous embodiment, said propagation further comprises propagation of said first position to said additional further position and propagation of said second position to said further position.

This is advantageous in that it has the effect, that then both the start and target point of the established robot trajectory can be propagated enabling the new start and target positions from one cycle to the next.

In an advantageous embodiment, said motion profile is determined by said established robot arm trajectory.

The motion profile describes the position of the robot joints at positions of the established robot arm trajectory i.e., the motion profile reflects the position of the robot joints and the relationship between robot joints at positions of the established robot arm trajectory.

In an advantageous embodiment, said motion profile describe the position of said robot joints at said first position, said second position and said plurality of intermediate positions.

A given tool center point position in space is determined by the positions of the robot joints. The position of a robot joint depends on the adjacent robot joint towards the robot base. Hence, the position in space of the robot joints in successive position of a robot arm trajectory is in this document referred to as a motion profile.

In an advantageous embodiment, said motion profile describe the position of said robot joints on said robot arm trajectory between said first position and said second position.

In an advantageous embodiment, said joint space propagation is performed by propagating a robot joint angle of one or more robot joints of said robot arm by a robot joint offset.

The position of a robot in space can be described in joint space by a joint angle for each of the robot joints in that angle. Accordingly, the same (X, Y, Z) position of the tool center point in the Cartesian space can be described by different combinations of joint angles. Put in words, the robot arm can position the tool center point in a position with a plurality of different combinations of robot joint angles. It should be noted that in periphery of the robot arm workspace, due to restrictions of freedom of movement of the robot arm, etc. sometimes the different combinations are only a few or only one combination of robot joint angles.

A robot joint offset should be understood as an angle that is added to a robot joint angle of a robot joint, when the robot arm is in one of the first, second or intermediate positions. It is to be understood that the joint offset can be both a negative and a positive angle such that the offset of joint angles can be provided in both directions of rotation of the robot joints.

In an advantageous embodiment, an offset of an intermediate position in said transformed robot arm trajectory from its position in said established robot arm trajectory is below an offset threshold.

The offset of the intermediate position may comprise a distance in cartesian space and/or an angular difference in joint space of one or more robot joints.

In an advantageous embodiment, the distance an intermediate position is displaced from its position in said established robot arm trajectory to its position in said transformed robot arm trajectory is below a displacement distance threshold.

The offset threshold, e.g. the displacement distance threshold, ensures that the transformed robot trajectory stays within a distance controlled by the controller and thereby by the person programming the controller. Hence the offset threshold or displacement distance threshold can be seen as constraints under which the robot controller operates when propagating the established robot trajectory.

In an advantageous embodiment, said joint space propagation is a nonlinear propagation of robot joint offsets.

Nonlinear propagation should, in an embodiment, be understood as a nonlinear displacement of the positions comprised by the robot trajectory to establish a transformed robot arm trajectory maintaining the original motion profile. In an embodiment, the nonlinear displacement is implemented by the robot controller by adding robot joint offsets to the robot joints in the positions comprised by the established robot arm trajectory. Hence, along the robot trajectory, robot joint offsets, which are different in size (different size angles), are added to the robot joints thereby displacing the positions of the robot trajectory.

Hence as an example, if the target position is propagated in space to the further position, then the closer the robot arm is to this new target position, the more the positions of the established robot trajectory is displaced. The same is also true if the start position is propagated in space, then the robot trajectory starts in the propagated start position and the closer, the robot is to the target position, the less, the points of the established robot arm trajectory is propagated.

In an advantageous embodiment, said joint space propagation is a nonlinear propagation of robot joint offsets made by said robot controller in joints space.

A joint space propagation is a mathematical very complex operation and thus in practise not possible or at least very time consuming to perform manually. This is the reason why such propagation historically has been made in the Cartesian space despite the singularity problems associated therewith. Hence the joints space propagation suggested by the inventors of the present invention adds flexibility to the transformed robot trajectory by propagating in joints space thereby avoiding almost all of the singularity problems.

In an advantageous embodiment, said joint space propagation is a nonlinear propagation of robot joint offsets in at least part of said plurality intermediate positions, in said first position or in said second position.

This is advantageous in that it has the effect, that the robot is starting, moving through or stopping in new points in space according to the same motion profile i.e., with its joints positioned in space as they were during the established trajectory, but now with the joint offsets required to enable the robot to start, move through or end in the new points i.e. following the transformed robot trajectory. In this way the robot may follow the motion profile of the recorded robot trajectory while starting its transformed trajectory a spatial distance from the first position of the established trajectory, ending its transformed trajectory a spatial distance from the second position of the established trajectory and/or move through points in space that are a spatial distance from the intermediate positions of the established trajectory.

In an advantageous embodiment, said robot joint offsets are applied to a plurality of said robot joints in at least one of said first position, said second position and intermediate positions.

Preferably at least one of the first and second position are propagated to the further position. To ensure a smooth transformed trajectory also a part of the intermediate positions is propagated. Hence in one position a robot offset may be added to one or all of the robot joints to establish the transformed trajectory.

In an advantageous embodiment, said offset is zero.

By adding an offset of zero to a robot joint angle in a given position of the established trajectory, the robot joint angle of that robot joint will not change in the transformed trajectory.

In an advantageous embodiment, said joint space propagation is a linear propagation of robot joint offsets.

A linear propagation should be understood as a displacement of points of the established robot trajectory that in percentages are equally displaced.

In an advantageous embodiment, said joint space propagation is applied to said established trajectory by applying a transfer function.

A transfer function should be understood as the relationship between the joint offset and the established robot trajectory i.e., for a given point on the established trajectory, the transfer function describes the joint offset. It should be noted that a transfer function in this context should not be understood as a one-step function where the entire propagation is applied to one position i.e., in one step.

Applying a transfer function is advantageous in that it has the effect, that the joint offset applied to the robot joints can be controlled automatically, and continuously applied to robot joints as the robot arm moves through positions of the established trajectory. The joint offsets described by the transfer function may be added to or subtracted from the established robot trajectory to obtain the transformed robot trajectory.

In an advantageous embodiment, said transfer function is implemented as a sigmoid transfer function.

Using a sigmoid transfer function is advantageous in that by the definition of the sigmoid function, the location of positions of the robot trajectory that is to be displaced and how much these positions are to be displaced, is defined. More specific, the sigmoid transfer function has the advantage that a position on the established robot trajectory is displaced more towards the end point (first or second position) that is displaced to the further position in the transferred robot trajectory. In addition, the sigmoid transfer function will not displace the opposite end of the established robot trajectory very much.

In an advantageous embodiment, said transfer function is implemented as a smooth step function.

An example of a smoothed step function may include an Euler function.

In an advantageous embodiment, said transfer function is implemented as two or more linear functions.

Using two or more linear functions, would also provide a non-linear transformation of the established robot trajectory between the first and second positions. The transformed robot trajectory may thus be constructed by a plurality of linear functions.

In an advantageous embodiment, said transfer function is applied to said established robot arm trajectory at each robot program cycle.

Typically, the transfer function is used on the established robot arm trajectory. Hence, the positions comprised by the transferred robot arm trajectory would in this example all be established by applying a joint offset derived from the transfer function independent of the cycle number. The cycle number should be understood as the number of times the robot program is executed to control the robot arm along the robot trajectory.

For each of these cycles a new further position may be established e.g., by use of cameras, sensors, preprogrammed patterns, or any combination thereof.

According to an embodiment, said transfer function and/or parameters of said transfer function may be provided to the robot controller by a user via a user interface.

The transfer function and/or parameters of the transfer function may be provided to the robot controller by a user via a user interface. Thus, a user may provide a transfer function to the robot controller, provide parameters for a transfer function already employed by the robot controller, or provide both the transfer function and parameters of the transfer function. Such parameters may for example relate to which position in the robot arm trajectory that propagations should initiate. Being able to provide such information (i.e., transfer function and/or parameters thereof) is advantageous in that a user may ensure that the propagation is better adapted to the new situation necessitating the transformation of the robot arm trajectory.

According to an embodiment, said method comprises a step of providing a propagation starting point, said propagation starting point defining a point along said robot arm trajectory from which said propagation is carried out.

By a propagation starting point may be understood a point along the robot arm trajectory, e.g. an intermediate position along the robot arm trajectory, from which a propagation of the remaining part of the robot arm trajectory is intended (i.e., the part of the robot arm trajectory in between the propagation starting point and the second position). Providing a propagation starting point is advantageous in that it allows for a dynamic and efficient adjustment of the transfer function propagation based on the specific characteristics of the given trajectory.

According to an embodiment, said propagation starting point is user-defined.

According to an embodiment, said propagation starting point is provided using a computer-implemented algorithm. For example, the propagation starting point may be determined by applying an algorithm such as the Ramer-Douglas-Peucker Algorithm.

According to an alternative embodiment, said method comprises a step of providing a propagation ending point, said propagation ending point defining a point along said robot arm trajectory from which no further propagations are carried out.

Alternatively to providing a propagation starting point, a propagation ending point may be provided. The propagation ending point may likewise be user-defined or provided by a computer-implemented algorithm. Defining a propagation ending point may for example be advantageous when a propagation is carried out at the beginning of a robot arm trajectory, e.g., propagation from the second position to the further position when the second position is a start position of said established robot arm trajectory.

In an advantageous embodiment, the method described in any of the paragraphs [0005]-[0098] is implemented on a robot arm described in any of the paragraphs [0100]-[0107].

Moreover, in an aspect, the invention relates to a robot arm comprising a plurality of robot joints mechanically connecting a robot base to a robot tool flange wherein a robot controller is configured for controlling movement of said plurality of robot joints and thereby movement of said robot tool flange, wherein said robot controller is configured to establish a robot arm trajectory, wherein said robot controller is configured to apply a transfer function to said established robot arm trajectory to establish a transformed robot arm trajectory, wherein said robot controller is configured to establish positions of said transformed robot arm trajectory by establishing a joint space propagation of positions comprised by said established robot arm trajectory.

The positions of said transformed robot arm trajectory and the positions comprised by said established robot arm trajectory may also be referred to as spatial positions.

In an advantageous embodiment, said joint space propagation is based on a difference between spatial coordinates of a position of said established robot arm trajectory and spatial coordinates of a further position.

The further position is not comprised by the established robot arm trajectory it is defined during programming of the robot program as a spatial position such as start position or target position of the transformed robot arm trajectory.

In an advantageous embodiment, said established robot arm trajectory and said transformed robot arm trajectory have the same motion profile.

The motion profile should be understood as the profile of the movement of the robot arm between a start position and a target position of the trajectory.

In an advantageous embodiment, said robot arm is a multipurpose robot arm having six axis.

In an advantageous embodiment, the robot arm described in any of the paragraphs [0100]-[0106] implements the method described in any of the paragraphs [0005]-[0098].

### THE DRAWINGS

For a more complete understanding of this disclosure, reference is now made to the following brief description, taken in connection with the accompanying drawings and detailed description, wherein like reference numerals represent like parts. The drawings illustrate embodiments of the invention and elements of different drawings can be combined within the scope of the invention:

FIG. 1 illustrates a robot system as known in the prior art,

FIG. 2 illustrates an established and a transformed trajectory having the same motion profile according to an embodiment of the invention,

FIG. 3 illustrates examples of a transfer function with which an established robot arm trajectory is transformed according to an embodiment of the invention, and

FIG. 4a-f illustrates propagation of robot joint angles from an established robot arm trajectory to a transferred robot arm trajectory.

### DETAILED DESCRIPTION

The present invention is described in view of exemplary embodiments only intended to illustrate the principles of the present invention. The skilled person will be able to provide several embodiments within the scope of the claims.

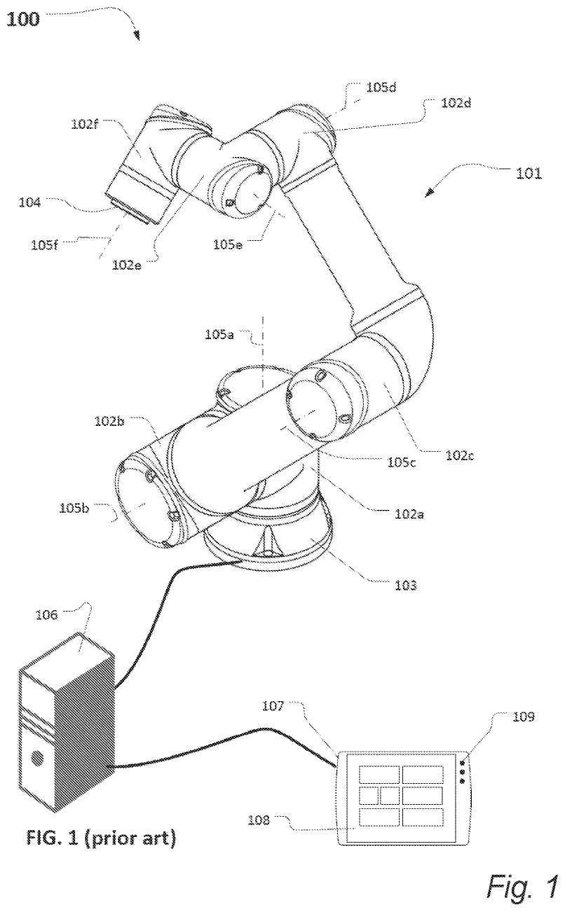

FIG. 1 illustrates a robot system 100 as known in the prior art. The robot system comprises at least one robotic arm 101 and at least one robot controller 106 configured to control the robotic arm.

The robotic arm 101 comprises a plurality of robot joints 102a, 102b, 102c, 102d, 102e, 102f connecting a robot base 103 and a robot tool flange 104. A base joint 102a is configured to rotate the robotic arm around a base axis 105a (illustrated by a dashed dotted line); a shoulder joint 102b is configured to rotate the robotic arm around a shoulder axis 105b (illustrated by a dashed dotted line); an elbow joint 102c is configured to rotate the robotic arm around an elbow axis 105c (illustrated by a dashed dotted line); a first wrist joint 102d is configured to rotate the robotic arm around a first wrist axis 105d (illustrated by a dashed dotted line) and a second wrist joint 102e is configured to rotate the robotic arm around a second wrist axis 105e (illustrated by a dashed dotted line). Robot joint 102f is a robot tool joint comprising the robot tool flange 104, which is rotatable around a tool axis 105f (illustrated by a dashed dotted line). The illustrated robotic arm is thus a six-axis robotic arm with six degrees of freedom with six rotational robot joints, however it is noticed that the present invention can be utilized in robotic arms comprising less or more robot joints and that some of the robot joints may be provided as a prismatic robot joint translating two or more robot parts in relation to each other.

The robot joints comprise a robot joint housing and an output flange rotatable or translatable in relation to the robot joint housing and the output flange is connected to a neighbour robot joint either directly or via an arm section as known in the art. The robot joint comprises a joint motor configured to rotate or translate the output flange in relation to the robot joint housing, for instance via a gearing or directly connected to the motor shaft. The robot joint housing can for instance be formed as a joint housing and the joint motor can be arranged inside the joint housing and the output flange can extend out of the joint housing. Additionally, the robot joints can comprise at least one joint sensor providing a sensor signal for instance indicative of at least one of the following parameters: an angular and/or linear position of the output flange, an angular and/or linear position of the motor shaft of the joint motor, a motor current of the joint motor or an external force and/or torque trying to rotate the output flange or motor shaft. For instance, the angular position of the output flange can be indicated by an output encoder such as optical encoders, magnetic encoders which can indicate the angular position of the output flange in relation to the robot joint. Similarly, the angular position of the joint motor shaft can be provided by an input encoder such as optical encoders, magnetic encoders which can indicate the angular position of the motor shaft in relation to the robot joint. It is noted that both output encoders indicating the angular position of the output flange and input encoders indicating the angular position of the motor shaft can be provided, which in embodiments where a gearing have been provided makes it possible to determine a relationship between the input and output side of the gearing.

The robot system may also comprise an end effector (not illustrated) attached to the robot tool flange, and it is to be understood that the end effector can be any kind of end effectors such as grippers, vacuum grippers, magnetic grippers, screwing machines, welding equipment, gluing equipment, dispensing systems, painting equipment, visual systems, cameras etc.

The robot system comprises at least one robot controller 106 configured to control the robotic arm 101. The robot controller is configured to control the motions of the parts of the robotic arm and the robot joints for instance by controlling the motor torque provided to the joint motors based on a dynamic model of the robotic arm, the direction of gravity acting and the joint sensor signals. The controller can be provided as an external device as illustrated in FIG. 1 or as a device integrated into the robotic arm or as a combination thereof.

The robot system can be controlled by a robot controller according to a robot program, where said robot program specifies a number of robot tasks and an order of execution of the robot tasks where the robot tasks define a number of actions that the robot system shall perform. The robot controller can comprise an interface device 107 enabling a user to control and program the robot system. The interface device can for instance be provided as a teach pendant as known from the field of industrial robots which can communicate with the controller via wired or wireless communication protocols. The interface device can for instanced comprise a display 108 and a number of input devices 109 such as buttons, sliders, touchpads, joysticks, track balls, gesture recognition devices, keyboards, microphones etc. The display may be provided as a touch screen acting both as display and input device. The interface device can also be provided as an external device configured to communicate with the robot controller, for instance in form of smart phones, tablets, PCs, laptops etc.

The general ways to control a robot is either be in joint space or Cartesian space. Hence, the robot controller 106 is using at least two types of motion commands to make the robot arm move. For joint space motion a desired set of robot joint positions is specified e.g., recorded at actual robot joint positions. This set of robot joint positions is referred to as the robot trajectory. The robot controller 106 then moves the robot arm by translating or rotating each robot joint to the desired joint positions one after the other to move the robot arm according to the established robot trajectory. For Cartesian space motion a set of desired poses of the end effector (or tool center point) is specified again e.g., recorded at actual positions of the end effector. This set of poses of the end effector is referred to as the robot trajectory. The robot controller 106 then moves the robot arm by calculating the inverse position and velocity kinematics of the robot arm. Singularities may arise when these calculations fail.

In general, singularity may occur when movement of the robot arm is blocked in certain directions i.e., loses one or more degrees of freedom. This may occur if e.g., the axes of two robot joints 102a-102f of the robot arm 101 are moved so that they are or are close to parallel. Furthermore, singularities may also occur at limits of reach of the robot arm.

When a robot program is made to control the robot arm to a new start or target position of the robot trajectory in subsequent cycles and these new start- and/or target-positions (above referred to as further or additional further positions) are defined in the Cartesian space a risk of singularities arises. This risk is significantly mitigated if not completely eliminated when defining these new start- and/or target-positions in joint space.

However, even for the experienced robot programmer or integrator, it is extremely difficult to determine a new start and or target position in joint space due to the inherent angular dependencies from one robot joint to the other. Further, it is extremely difficult to predict effect in joint space by changes in the Cartesian space. Accordingly, by the present invention the needed level of experience of the robot programmer is reduced. Hence, a robot program/joints pace propagation can be made without knowledge of the correlation between singularities and perpendicular positions in that the propagation is made in joint space.

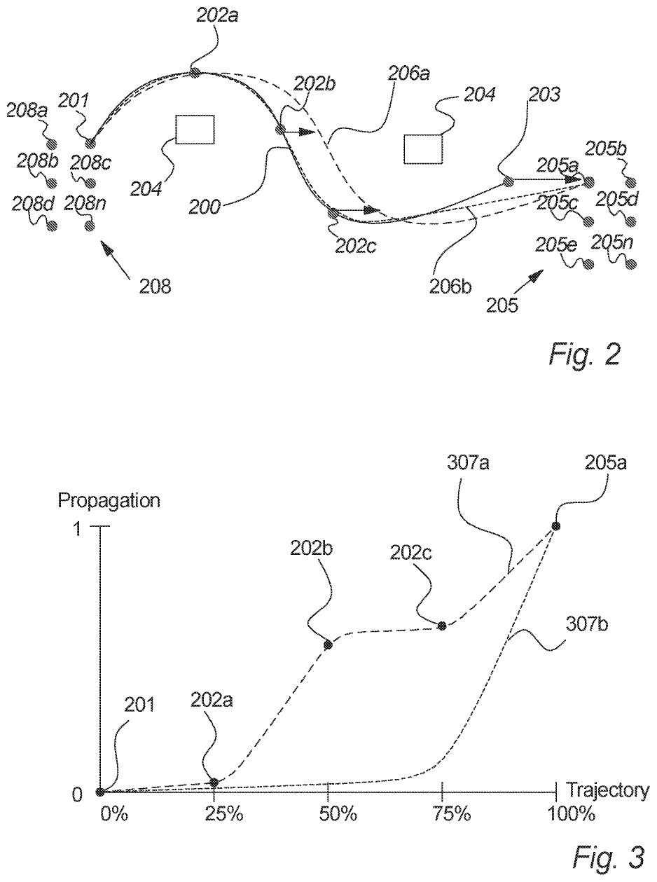

FIG. 2 illustrates a robot arm trajectory 200 (simply referred to as robot trajectory) having an S-shaped motion profile according to an embodiment of the invention. The robot trajectory 200 starts in the start position 201, moves through intermediate positions 202a-c and ends in the target position 203. In this particular embodiment, the start position 201 may also be referred to as a first position and the target position 203 may also be referred to as the second position.

The robot trajectory 200 may be established in various of way including recording actual movement/positions/angles of the robot joint 102a-102f and thus of the robot arm 101, programming via a user interface such as teach pendent/user interface 107, etc. After a user has established the robot trajectory 200 (also referred to as established robot trajectory), the robot arm 101 may repeat the established robot trajectory 200 in successive cycles.

The present invention can be applied to any type of robot trajectories but is especially advantageous to apply to the particular type of robot trajectories that change at least one of the start position 201, the target position 203 and/or any of the intermediate positions 202a-c from one cycle to the next cycle. An example of an automated process making use of this type of robot trajectory 200 is a pick and place application. With reference to FIG. 2, a plurality of objects is to be picked up at spatial positions defining start positions (201 or 208a-n) and placed at spatial positions defining target positions 205a-n.

As mentioned, the robot trajectory 200 may be established e.g., by recording robot arm positions in space. The positions may be recorded as individual positions between which the robot controller 106 selects e.g., the shortest path. Alternative, the positions may be recorded with a given sample frequency as the robot arm 101 is moved in space. In this way the number of intermediate positions 202 is defined by the sample frequency. Alternatively, a programmer (user) may move the robot arm 101 from point to point while programming/defining specific tasks the robot arm 101 should carry out e.g., in the point or on its way to that point. Alternatively, the recording of a robot trajectory 200 may be performed in discrete steps of position or joint angles. In this way, a new point is recorded if the robot arm 101 or a robot joint 102a-f hereof has moved more than a predefined distance or angle. Hence, the robot trajectory could be defined as changes of angles of robot joints 102a-f recorded over time.

According to yet another alternative, the robot trajectory can be established by an algorithm such as a path planner and imported by the robot controller 106. Hence, the robot trajectory 200 could be said to be established by an industrial robot arm trajectory tracking system.

As mentioned, a motion profile is associated with the robot trajectory 200. The robot trajectory 200 may be changed without changing the motion profile if the changes are minor. In this particular embodiment the motion profile is S-shaped to avoid obstacles 204 within range of the robot arm 101. The motion profile may be important to maintain when propagating the robot trajectory 200 e.g., by propagating the spatial position of the target position 203 to the spatial position of the further position 205a. This is because the transformed arm robot trajectory 206a (simply referred to as transformed robot trajectory) established as consequence of the propagation of the target position 203 also need to avoid the obstacles 204.

The motion profile of the robot trajectory may in part be defined by manually added waypoints. During the joint space propagation such waypoints may be propagated as the intermediate positions 202. In an embodiment, the joint space propagation may be configured to propagate such waypoints or force the transformed robot trajectory 206a through such waypoints. Alternatively, such waypoints may be used to split up the robot trajectory 200 into two or more sub-robot trajectory parts that individually may be propagated.

When the established or original robot trajectory 200 including its motion profile is established, the need for manually defining additional waypoints on the transformed robot arm trajectory 206a to avoid obstacles, may be avoided. This is because the motion profile is maintained i.e., it is possible to maintain a curve around a particular obstacle. By maintaining should be understood a controlled displacement of the established robot trajectory 200 defined e.g., by a transfer function as described below and/or by a displacement distance threshold ensuring that points/parts of the established robot trajectory 200 is/are not displaced more than the displacement distance threshold.

A robot trajectory 200 as described above having a plurality of start positions 201 and a plurality of target positions 203 required more effort from the programmer of the robot program than a robot program controlling a robot trajectory having the same start and target position cycle after cycle.

In the art, it is known to define the spatial positions of the robot trajectory 200 in the Cartesian space and thus let the robot arm 101 move linear from one position to the next. As mentioned, this may lead to singularity issues which is avoided by the present invention. The spatial positions and the difference (distance) between e.g., target position and a new target position (further position) may still be defined as X, Y, Z coordinates in the Cartesian space, but instead of the linear movement in the Cartesian space, the robot arm 101 is moved in joint space based on a translation of the positions and distance defined in the Cartesian space. An example of the result of this translation is the transformed robot trajectory 206a.

The translation includes joint space propagating (also sometimes simply referred to as propagating) a plurality of spatial positions (also sometimes simply referred to as positions in this document) from the established robot trajectory 200 to new position of the transformed robot trajectory 206a. The size of this propagation of positions may be determined by the linear distance from an original position of the established robot trajectory 200 to a desired position of that original position in the transformed robot trajectory 206a. With this said, if the distance between the target and further target positions are recorded, typically, the positions of the robot joints 102a-f in joint space is already known, no translation between Cartesian and joints space is needed.

Hence, the size of the propagation can be established by considering the difference (ΔQ) between e.g., the target position (Q_{TP}) of the recorded robot trajectory and the further position (Q_{FP}), the desired new target position in the transformed robot trajectory. As mentioned, this difference may be a linear difference established between to positions in the Cartesian space or angular difference established between robot joint angles of one or more robot joints at two positions in the joint space.

This can be described by an equation as follows:

$$Δ Q = {Q}_{FP} - {Q}_{TP} \qquad [ eq . 1 ]$$

By eq. 1, for each cycle, the difference between the original target position (Q_{TP}) of the recorded robot trajectory and the new position of the original target position on the transformed trajectory can be established.

Then the joint space propagation may be implemented by adding this difference ΔQ multiplied by a propagation factor to positions “n” (e.g. the intermediate positions 202a-c) throughout the robot trajectory (RT). In this way for any position “n” on the established robot trajectory 200, a new position (Q_{NP}) can be established on the transformed robot trajectory 306a:

$${Q}_{NP} = RT [ n ] + propagation factor * Δ Q \qquad [ eq . 2 ]$$

Hence, a new transformed robot trajectory is calculated for each new cycle by establishing the difference ΔQ, multiply the difference ΔQ and a propagation factor and added the result to the position “n” of the established robot trajectory that is to be propagated. Thus, the difference ΔQ together with the propagation factor is determining for the propagation of the intermediated positions 202a-c and thereby the transformed robot trajectory 206a.

It should be noted that the difference ΔQ may be based on the original target position of the established robot trajectory in each successive operation cycles as described above, or it may be based on the new target position from the previous operation cycle.

As mentioned, the spatial positions of the new target positions i.e., the further positions 205a-205n may change from one cycle to the next. The difference between the original target position 203 and the further positions 205a-205n may be determined by the robot controller 106 based on input from sensors such as proximity sensors, cameras and the like.

It should be noted that the person programming the robot controller 106 may restrict the robot joint offset by adjusting a displacement distance threshold. This threshold ensures that the distance between the established robot trajectory and the transformed robot trajectory does not exceed the threshold value and thereby prevents collision between robot arm 101/object and obstacles 204. The displacement distance threshold may also be determined by the robot controller 106 based on information of geometry of the object to be handled location and geometry of the obstacles 204, etc.

The propagation factor is in an embodiment determined by a transfer function according to the principles illustrated on FIG. 3. The transfer function 307a illustrated in FIG. 3 describes the propagation factor as function of robot trajectory. Hence, along the X-axis (or horizontal axis) the robot trajectory is represented between 0% and 100% i.e., at 0% the robot arm 101 has not started to move along the robot trajectory yet. At 50% the robot arm 101 is halfway through the robot trajectory and at 100% the robot arm 101 has completed the robot trajectory. Further, along the Y-axis (or vertical axis) the propagation factor is represented between 0 and 1 i.e., at 0 there is coincidence between a position (such as start position) of the established robot trajectory and of the translated robot trajectory. At 1 the original target position is completely propagated to the target position of the translated robot trajectory.

Comparing the transfer function 307a of FIG. 3 with the trajectories 200, 206a of FIG. 2 it is noted that the intermediated positions 202b, 202c at approximately 50% and 75% of the robot trajectory, are propagated more than the first intermediate position 202a approximately at 25% of the robot trajectory.

Hence, by changing the transfer function 307a to the transfer function 307b, the transformed trajectory 206a will change to the transformed trajectory 206b. In this way, it is possible to propagate the positions of the established robot trajectory 200 as desired by changing/adjusting the transfer function. Such adjustment may be made by drag and drop via a display on a user interface, such as interface device/teach pendent 107. Accordingly, the joint space propagation could be said to be a dynamic translation/displacing of a robot trajectory.

A plurality of different transfer functions may be used to propagate a robot trajectory according to the present invention. Example could be the Sigmoid and Euler transfer functions just to mention a few.

As mentioned, it is desired to maintain the motion profile of the established robot trajectory, however it is possible to select a transfer function or perform the joint space propagation in a way where the motion profile is not maintained. As an example, could be mentioned, that the S-shaped motion profile illustrated in FIG. 2, during the propagation is transformed to a linear motion profile between the start and target position 201, 203.

Summing up, the longer part of the ends of the robot trajectory without propagation positions of the established robot trajectory 200, the more the established robot trajectory 200 has to be propagated at the middle part.

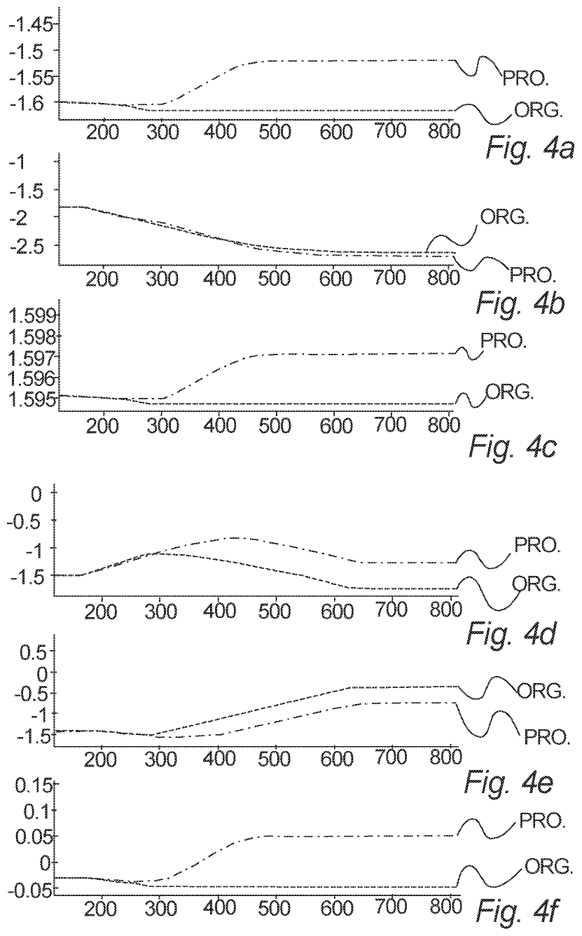

FIGS. 4a-f illustrate how the joint space propagation described above affects the individual robot joints 102a-f. FIG. 4a is the robot joint closest to the robot base, FIG. 4f is the robot joint closest to the tool center point and FIG. 4b, 4c, 4d, 4e illustrates the robot joints therebetween. The robot arm trajectory is illustrated along the X-axis (or horizontal axis) i.e. the unit on the X-axis is time or time samples. A representation of the robot joint angle (in Radians) is illustrated along the Y-axis (or vertical axis). The dashed curve form denoted ORG illustrated the robot joint angles of the established robot trajectory 200 and the dash dot curve form denoted PRO illustrated the robot joint angles of the transformed robot trajectory 206a-b.

As illustrated from a comparison of the propagated robot joint angles PRO the robot controller 106 selectively change the angles of the individual robot joints 102a-f. Typically, the robot controller 106 has more than one option of how to control the robot joint angles for the robot arm 101 to follow the transformed robot trajectory 206a-b. More specific the robot controller 106 has different sets of robot joint offsets that when applied to the robot joints 102a-f result in a movement of the robot arm along the transformed robot trajectory. In the situation where the robot controller 106 has several options, the robot controller 106 may chose the option resulting in the fastest cycle time or the option resulting in the least change of robot joint angles.

Also, it is illustrated that the timing of adding the offset is almost synchronous in that the angles of the two curves on each of the graphs shown in FIGS. 4a-4f starts by following each other until after 300. Then until between 400 and 500, the robot joint angle offsets are added to the robot joint angles of the established robot trajectory i.e., the curve forms denoted ORG at FIG. 4a-4f. After 500 the robot joint angles are parallel i.e., no additional robot joint offsets are applied to the established robot trajectory.

The robot joint offsets applied to the robot joints 102a-f in the example illustrated on FIG. 4a-f vary from almost no offset added to the robot joint illustrated at FIGS. 4b and 4c to larger offsets added to the robot joints illustrated at FIGS. 4a and 4f. In some embodiments, it is advantageous not to propagate the robot trajectory 200 too much or not at all at the ends (start or target positions 201, 203) in that typically, here other applications/obstacles are located.

The above description mostly concerns displacing the target position 203 and intermediate positions 202. However, it should be underlined, that also the start position 201 can be displaced e.g., to the additional further positions 208a-n illustrated on FIG. 2. The same transfer function may be used, the joint space propagation then just start by propagating from the target position 203 and ending at the start position 201. Also, it should be underlined that both ends of the robot trajectory 200 may be displaced according to the same transfer function in the same cycle.

It should be mentioned that speed and acceleration of the motion of the robot arm 101 along the transformed robot trajectory 206a-b can be handled separately. Hence, if the robot trajectory 200 is recorded, only the positions are sampled and not time. The speed and acceleration are in an embodiment the same during the established robot trajectory 200 and during the transformed robot trajectory 206a-b.

From the above it is now clear, that the present invention relates to a method and a robot arm implementing the method for transforming a robot arm trajectory having a motion profile in space, preferably in joint space so that the transformed robot arm trajectory has a new starting position and/or a new target position compared to the originally established robot arm trajectory. The transformation is made based on a transfer function that for a plurality of positions of the original established robot arm trajectory propagates robot joint angles by an offset derived from the transfer function while maintaining the motion profile of the established robot trajectory.

The present invention is advantageous at least in that changing of target position for a robot trajectory can be made as a gradual transition, it may be used to substitute the blend function and it lowers the need for experience for the robot programmer.

The invention has been exemplified above with the purpose of illustration rather than limitation with reference to specific examples of methods and robot systems. Details such as a specific method and system structures have been provided in order to understand embodiments of the invention. Note that detailed descriptions of well-known systems, devices, circuits, and methods have been omitted so as to not obscure the description of the invention with unnecessary details.

### LIST

100. Robot system
101. Robot arm
102a-f. Robot joints
103. Robot base
104. Robot tool flange
105a-f. Robot joint axis
106. Robot controller
107. Interface device (also sometimes referred to as teach pendent)
108. Display
109. Input devices
200. Robot arm trajectory
201. Start position
202a-c. Intermediate positions
203. Target positions
204. Obstacles
205a-n. Further position
206a-b. Transformed robot arm trajectory
208a-n. Additional further position
307a-b. Transfer function
ORG. Robot joint angle for original (established) robot trajectory
PRO. Robot joint angle for the transformed robot trajectory

1. A method of transforming a robot arm trajectory having a motion profile, wherein said robot arm comprises a plurality of robot joints controllable by a robot controller to follow said robot arm trajectory, the method comprising the steps of:
establish said robot arm trajectory including a first position, a second position and a plurality of intermediate positions extending between said first position and said second position, wherein said established robot arm trajectory include coordinates of said first position and of said second position,
establish coordinates of a further position not forming part of said established robot arm trajectory,
establish a difference between said coordinates of said second position and said coordinates of said further position,
establish a transformed robot arm trajectory including said first position, said further position and a plurality of intermediate positions,
wherein at least a part of the plurality of intermediate positions of the transformed robot arm trajectory is based on a propagation of at least a part of the plurality of intermediate position of the robot arm trajectory, wherein said propagation:
is a joint space propagation enabling said transformed robot arm trajectory to reach said further position while maintaining said motion profile, and
is based on the difference between said coordinates of said second position and said coordinates of said further position.

2. A method according to claim 1, wherein said coordinates of said first position, said second position, and said further position are spatial coordinates, and wherein said difference between said coordinates of said second position and said coordinates of said further position is a spatial distance.

3. (canceled)

4. A method according to claim 1, wherein said robot arm trajectory and thereby said motion profile is established by a robot controller recording succeeding positions of said plurality of robot joints.

5. (canceled)

6. A method according to claim 1, wherein said first position, said second position and said plurality of intermediated positions are defined by said robot controller as positions in joint space.

7. A method according to claim 1, wherein said further position is provided to the robot controller by a user via a user interface to said robot controller as a position defined in the cartesian space, said robot controller is configured to translate said further position defined in the cartesian space to a position defined in joint space.

8. (canceled)

9. A method according to claim 1, wherein said further position is recorded by the robot controller as a current position of said robot in joint space.

10. A method according to claim 1, wherein an additional further position is determined as a spatial distance from said first position, and wherein said propagation further comprises propagation of said first position to said additional further position and propagation of said second position to said further position.

11. (canceled)

12. (canceled)

13. A method according to claim 1, wherein said motion profile is determined by said established robot arm trajectory.

14. (canceled)

15. A method according to claim 1, wherein said motion profile describes the position of said robot joints on said robot arm trajectory between said first position and said second position.

16. A method according to claim 1, wherein said joint space propagation is performed by propagating a robot joint angle of one or more robot joints of said robot arm of at least one of the plurality of intermediate positions of the robot arm trajectory by a robot joint offset.

17. A method according to claim 1, wherein an offset of an intermediate position in said transformed robot arm trajectory from its position in said established robot arm trajectory is below an offset threshold.

18. A method according to claim 1, wherein said joint space propagation is a nonlinear propagation of robot joint offsets.

19. A method according to claim 1, wherein said joint space propagation is a nonlinear propagation of robot joint offsets made by said robot controller in joints space.

20. A method according to claim 1, wherein said joint space propagation is a nonlinear propagation of robot joint offsets in at least part of said plurality intermediate positions, in said first position or in said second position.

21.-23. (canceled)

24. A method according to claim 1, wherein said joint space propagation is applied to said established trajectory by applying a transfer function.

25. A method according to claim 24, wherein said transfer function is applied to said established robot arm trajectory at each robot program cycle.

26. A robot arm comprising a plurality of robot joints mechanically connecting a robot base to a robot tool flange wherein a robot controller is configured for controlling movement of said plurality of robot joint sand thereby movement of said robot tool flange,
wherein said robot controller is configured to establish a robot arm trajectory,
wherein said robot controller is configured to apply a transfer function to said established robot arm trajectory to establish a transformed robot arm trajectory,
wherein said robot controller is configured to establish positions of said transformed robot arm trajectory by establishing a joint space propagation of positions comprised by said established robot arm trajectory.

27. A robot arm according to claim 26, wherein said joint space propagation is based on a difference between spatial coordinates of a position of said established robot arm trajectory and spatial coordinates of a further position.

28. A robot arm according to claim 26- or 27, wherein said established robot arm trajectory and said transformed robot arm trajectory have the same motion profile.

29. (canceled)
